(19) United States
(12) Patent Application Publication
(10) Pub. No.: US 2005/0212168 A1
(43) Pub. Date: Sep. 29, 2005

(54) Interchangeable mold blade

(75) Inventors: David A. Kesselman, York, PA (US); Edward V. Perone, York, PA (US)

Correspondence Address: VENABLE LLP, P.O. BOX 34385, WASHINGTON, DC, 20045-9998, US

(73) Assignee: Graham Packaging Company, L.P., York, PA (US)

(21) Appl. No.: 10/807,443

(22) Filed: Mar. 24, 2004

(51) Int. Cl. B29C 49/50; A23P 1/00

(52) U.S. Cl. 264/161; 425/527; 425/292; 425/196; 264/536; 29/525

(57) ABSTRACT

A blade arrangement includes a blade including a blade edge and a fastening element. The fastening element removably fastens the blade onto a first mold half in a pocket formed by complementary recesses of the first mold half and a second mold half, where the pocket extends over the mold halves.

### FIELD OF THE INVENTION

The present invention relates to an interchangeable mold blade.

### BACKGROUND OF THE INVENTION

In molding articles such as containers, pinch bars or blades are often used to cut the parison between adjacent molds. Because pinch bars and blades have different cutting properties, each type is selectively used for different tasks. For example, pinch bars can be useful for polypropylene but are not as effective with other materials, for example, polyethylene. Conventionally, however, the two types of the mold separation devices are not designed to be interchangeable, and thus, extra costs and time are required for switching the mold when a change in application or material requires a change in the separation device. For example, a switching of conventional pinch bars and blades from one type to the other often requires re-machining of the molds and/or mold parts that can involve dismantling of the molds and shipping to a mold shop, which incurs considerable time and expense. Hence, what is needed then is an improved mold blade that is interchangeable with a pinch bar or replacement blade.

### SUMMARY OF THE INVENTION

A blade arrangement includes a blade including a blade edge and a fastening element. The fastening element removably fastens the blade onto a first mold half in a pocket formed by complementary recesses of the first mold half and a second mold half, where the pocket extends over the mold halves.

### BRIEF DESCRIPTION OF THE DRAWINGS

The foregoing description of the invention will be apparent from the following, more particular description of an embodiment of the invention, as illustrated in the accompanying drawings wherein like reference numbers generally indicate identical, functionally similar, and/or structurally similar elements.

FIG. 1 depicts a blade arrangement for separating material in a mold according to an exemplary embodiment of the invention.

FIG. 2 depicts a pinch bar arrangement for separating material in a mold that is interchangeable with the blade arrangement according to an exemplary embodiment of the invention.

FIG. 3 depicts pinch bars having raised pinching areas according to an exemplary embodiment of the invention.

FIG. 4 depicts a high-speed molding machine according to an exemplary embodiment of the invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

In the following description and claims, the term “article” refers to any object subject to being separated in a mold and can include, for example, parison, containers, blocks and sheets. In general, articles are objects in an intermediate stage of manufacture. For example, an article can be a plastic container formed from extruded polymer tubes (i.e., parisons) during the manufacture of plastic bottles. The term “container” refers to any object capable of being used to contain gas, liquid or solid material and can include, for example, tubes, jars or bottles. The term “parison” refers to any polymer tube that is used for blow molding, and the term “material” refers to any element subject to being separated in a mold including articles, article parts, a parison and any other moldable elements. The term “separate” refers to any action of severing material and may include cutting and pinching off the material. The term “cut” refers to any action to sever material by using a blade. The term “pinch off” refers to any action to sever material by using two opposing raised areas, where the raised areas are aligned and form complementary opposing surfaces to sever material placed between them.

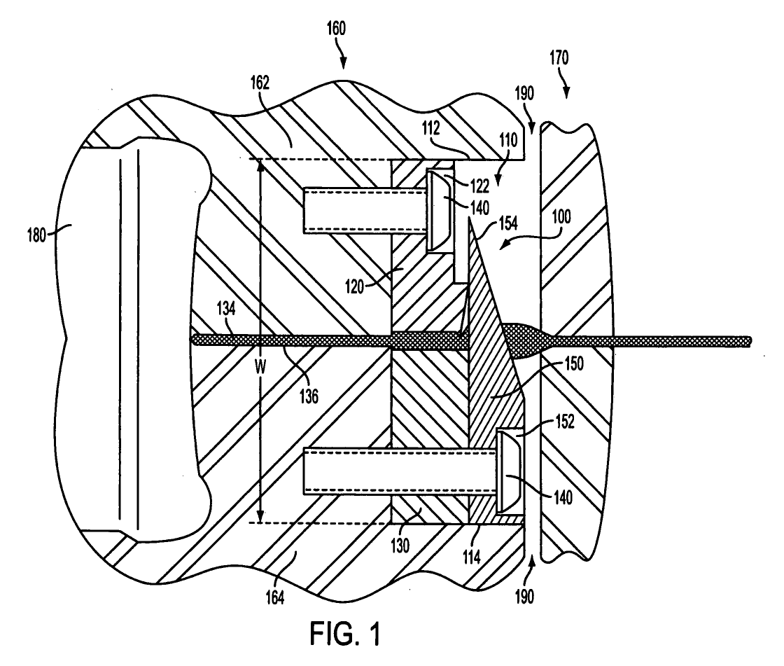

FIG. 1 depicts a blade arrangement 100 according to an exemplary embodiment of the present invention. The blade arrangement 100 is removably fastened in a pocket formed by complementary recesses 112, 114 formed by mold halves 162, 164, respectively, of a first mold 160, where the first mold 160 and a second mold 170 are separated by a gap 190. The dimensions and configuration of the blade arrangement 100 are such that the blade arrangement 100 and a pinch bar arrangement can be interchangeably fastened in the pocket 112, 114 onto the mold 160.

For example, a width W, length or height of the blade arrangement 110 may be the same as the corresponding measurement(s) of the pinch bar arrangement. Specifically, the blade arrangement 110 can have a width W of about 2½ inches or less, less than about 2 inches, or less than or about 1½ inches. In a conventional blow mold, the width of the blade arrangement typically extends over a substantial portion of the mold surface. For example, when the mold is closed, the blade arrangement can have a width of about 5 inches. In such a case, a bed blade and spacer are each about 2½ inches wide, since they are equally disposed on each mold half. The blade piece typically overlays the mold parting line by about ¾ inches, so a typical width of the blade is about 3¼ inches.

When pinch bars are used as a parison separation device, they can be placed in a pocket formed in the top surface of a mold. Thus, a mold designed with a pocket to accommodate a pinch bar does not have a solid top surface suitable for use with a conventional blade. The pocket is much smaller in width than a conventional blade arrangement, and can be about 2½ inches wide in a typical use. Thus, if a change in material is made or if parameters are changed in a way that makes use of a pinch bar unacceptable, then a new mold without a pocket must be used to manufacture the same containers in order to use an existing blade as a cutting device. Use of the present invention allows switching to a blade without such retooling. As a result of the need to fit the blade arrangement into a pocket, a substantial and previously unnecessary size reduction is required. Thus, in a typical blade arrangement according to the invention, the bed blade and spacer of the invention are each about 1¼ inches wide. The blade piece can still extend about ¾ inches past the parting line, and can therefore be about 2 inches wide. The blade 150 can have a width (i.e., the dimension in the same direction as W) of about 2 inches, less than 2 inches and less than or about 1½ inches. The bed blade 120 can have a width (i.e., the dimension in the same direction as W) of about 1¼ inches, less than 1¼ inches, and less than or about 3/4 inches. After the blade arrangement 100 is fastened onto the mold 160, it may fit substantially within the pocket 112, 114, or it may have a portion that protrudes beyond the pocket recesses 112, 114. The blade arrangement 100 may have a blade 150, a bed blade 120, a spacer 130 and screws 140.

The blade 150 may comprise a blade edge 154 for cutting material in a mold and a blade opening 152 for engaging a fastening element. The fastening element of the blade 150 may removably fasten the blade 150 onto a mold half (e.g., 164) and may be any fastening element including, but not limited to, screws, a pin, a friction-fit surface and any combination of fastening elements. The blade opening 152 may be optional and may not be required if, for example, a friction-fit surface is used to removably fasten the blade 150. When a friction-fit surface is used, the mold half 164 to which the blade 150 is attached may have its top portion extended over the top surface of the blade 150 so as to friction-fit the blade 150 within the recess 114 formed by the mold half 164.

A bed blade 120 complementary to the blade edge 154 of the blade 150 may be provided. The bed blade 120 may comprise a bed blade opening 122 for engaging a fastening element. The fastening element of the bed blade 120 may be any removable fastening element as described above and may be a same as or different type from the fastening element used for fastening the blade 150. The bed blade opening 122 may be optional and may not be required if, for example, a friction-fit surface is used to fasten the bed blade 120. When a friction-fit surface is used, the mold half 162 to which the bed blade 120 is attached may extend over the top surface of the bed blade 120 so as to friction-fit the bed blade 120 within the recess 112 formed by the mold half 162. The bed blade 120 and spacer 130 may be optional, where the spacer 130 adjusts the vertical placement of the blade 150 within the pocket 112, 140 so that the bed blade 120 and the blade 150 operate as complementary cutting pieces. When the bed blade 120 and the spacer 130 are used, the spacer 130 may be integrated with the blade 150 as one piece.

The first mold 160 may be placed adjacent to the second mold 170 as shown in FIG. 1, where each mold may produce articles in its turn. For example, the first and second molds 160, 170 may be adjacent molds in a ring of molds within a molding machine, where the first mold 160 trails the second mold 170 as the ring of molds rotates and the second mold 170 closes before the first mold 160 for molding an article. The second mold 170 may be optional and may have shapes and configurations identical to those of the first mold 160 (i.e., to create articles identical to those produced by the first mold 160) or shapes and configurations different from those of the first mold 160 (i.e., to create articles different from those produced by the first mold 160). The mold 160 may have the shapes and configurations in FIG. 1 (e.g., a flash pocket 136 for a parison 134 and a cavity for forming an article 180). Alternatively, the mold 160 may have any shape and configuration as long as the blade arrangement 100 can be installed in a pocket formed by mold halves and cut material in the mold. The mold 160 may produce articles by extrusion blow molding, for example.

As to a method of using the blade arrangement 100, material is placed initially at a separation location between the mold halves 162, 164. For example, a molten parison can be placed between two mold halves in an extrusion blow molding process or a molten plastic can be placed between mold halves in compression molding process. After the placement of the material between the mold halves 162, 164, the mold halves 162, 164 are closed and the material is cut by the blade arrangement 100. The material is then molded by the mold halves 162 and 164 to produce an article in, for example, a blow molding process. As an example of using the blade arrangement 100, initially a parison 134 may be placed between the mold halves of the first and second molds 160, 170, where the parison 134 may extend through the first and second molds 160, 170. Subsequently, the first mold 160 closes and the parison 134 is cut by the blade arrangement 100, where the closing of the first mold 160 may also squeeze the parison 134 placed between the mold halves 162, 164 to form a flash between them (e.g., in the flash pocket 136). After the parison 134 is cut by the blade arrangement 100, the parison 134 may be blow molded to form an article 180 in the first mold 160.

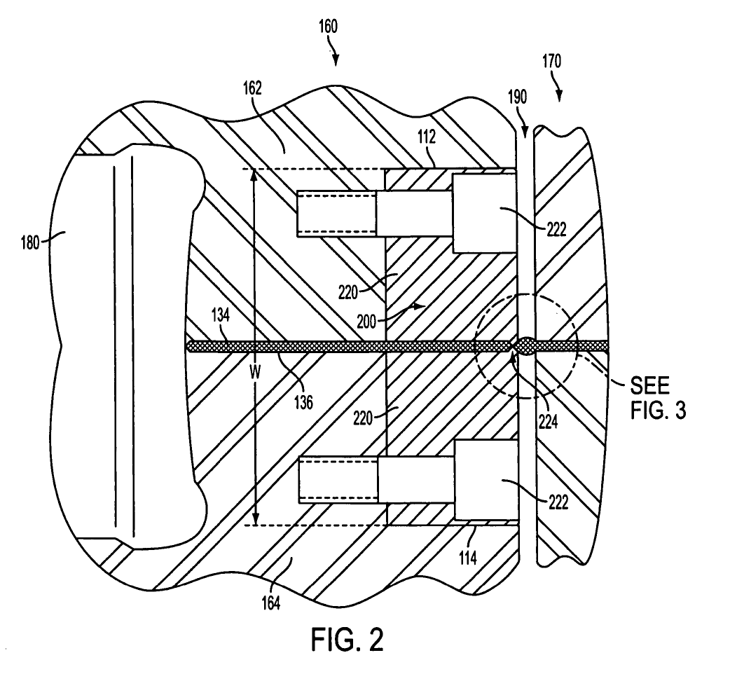

FIG. 2 depicts a pinch bar arrangement 200 that is interchangeable with the blade arrangement according to an exemplary embodiment of the present invention. The description of the blade arrangement 100 in FIG. 1 including the apparatus and methods also applies to the pinch bar arrangement 200 in FIG. 2 except where inconsistencies may arise. The dimensions and configuration of the pinch bar arrangement 200 are such that the blade arrangement 100 and the pinch bar arrangement 200 can be interchangeably fastened in the pocket 112, 114 onto the mold 160. When the pinch bar arrangement 200 is removably fastened onto the mold 160, it may fit substantially within the pocket 112, 114 or may have a portion that protrudes out of the pocket 112, 114. The pinch bar arrangement 200 may have pinch bars 220, where each pinch bar 220 has a pinch bar opening 222 and a raised pinching area 224 (see U.S. patent application Ser. No. 10/705,501 filed on Nov. 12, 2003 and incorporated herein by reference). The pinching areas 224 of the opposing pinch bars 220 are aligned with each other. As the mold 160 closes, the opposing pinch bars 220 come together, and an area of material (e.g., the parison 134) placed between them is pinched and severed by the opposing pinching areas 224. The pinching area 224 may have a flat surface, which is less subject to being worn out and dulling than sharp edges. Fastening elements may removably fasten the pinch bars 220 to mold halves 162, 164, where they may be any fastening elements including, but not limited to, screws, a pin, a friction-fit surface and any combination of fastening elements.

As to a method of using the pinch bar arrangement 200, material is placed at a separation location between the mold halves 162, 164, and the material (e.g., a parison or an article) is pinched off by the pinch bar arrangement 200 by closing the mold halves 162, 164. When they are acceptable for use in an application, pinch bars can be safer than blades because there are no sharp surfaces. Further, the pinching surface of the pinch bar can extend beyond the parting line surface of a mold half (when the mold is open), resulting in a positive cutting force when the mold closes. However, as previously described, pinch bars are not suitable for all applications.

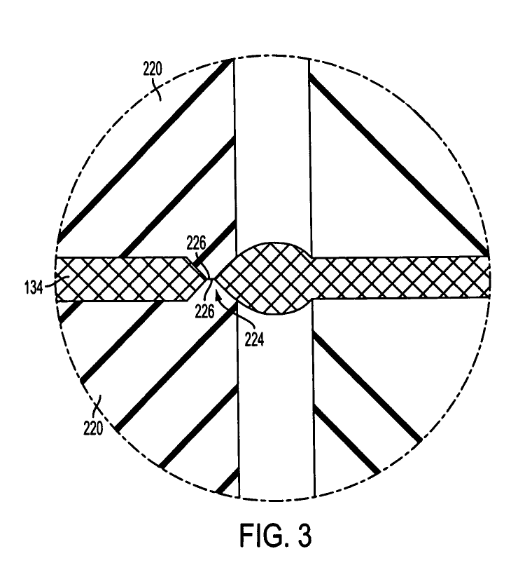

FIG. 3 depicts raised pinching areas 224 of opposing pinch bars 220, where the raised pinching areas 224 each have a flat surface 226 according to an exemplary embodiment. Alternatively, the flat surface 226 of the raised pinching areas 224 may be replaced by any pinching surface including, but not limited to, trapezoidal, round, oval, and rectangular shaped areas.

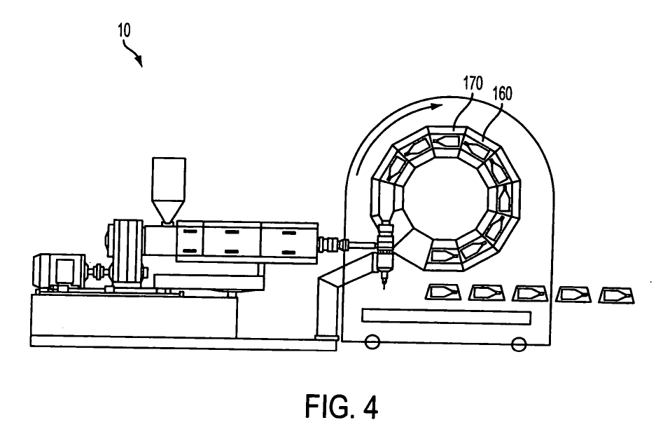

FIG. 4 depicts a high-speed molding machine 10 according to an exemplary embodiment of the invention. The molding machine 10 has a plurality of molds connected to form a rotary wheel, where as the wheel of molds rotate in a clockwise direction, each mold in its turn blow molds an article from a parison (see U.S. patent application Ser. No. 10/705,501 filed on Nov. 12, 2003).

By having a blade arrangement interchangeable with a pinch bar arrangement, a change of the separation device from one type to the other may be accomplished while the molds are in a molding machine (e.g., 10 in FIG. 4). By having the blade arrangement fastened onto a pocket formed by the mold halves, the overall maintenance of the blade arrangement and mold handling safety may be improved and the overall weight of the blade arrangement may be reduced.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A blade arrangement comprising:
a blade comprising a blade edge; and
a fastening element being adapted to removably fasten the blade onto a first mold half in a pocket formed by complementary recesses of the first mold half and a second mold half, wherein the pocket extends over the mold halves.

2. The blade arrangement of claim 1, further comprising a bed blade and a second fastening element adapted to removably fasten the bed blade onto the second mold half in the pocket formed by the complementary recesses, wherein the blade and the bed blade form complementary cutting pieces.

3. The blade arrangement of claim 1, wherein the fastening element comprises a screw.

4. The blade arrangement of claim 1, wherein the fastening element comprises at least one of a pin and a friction-fit surface.

5. The blade arrangement of claim 1, wherein the blade is adapted to cut material placed between the first and second mold halves.

6. The blade arrangement of claim 1, wherein the blade is adapted to fit substantially within the pocket.

7. A mold arrangement comprising:
first and second mold halves having complementary recesses that form a pocket extending over the first and second mold halves when the mold is closed; and
a blade comprising a blade edge and being removably fastened onto the first mold half in the pocket formed by the complementary recesses.

8. The mold arrangement of claim 7, further comprising a bed blade removably fastened onto the second mold half in the pocket formed by the complementary recesses, wherein the blade and the bed blade form complementary cutting pieces.

9. The mold arrangement of claim 7, wherein the blade is removably fastened onto the first mold half by at least one of a screw, a pin and a friction-fit surface.

10. The mold arrangement of claim 7, wherein the blade is adapted to cut material placed between the first and second mold halves.

11. The mold arrangement of claim 7, wherein the blade fits substantially within the pocket.

12. A method comprising:
removing a first cutting arrangement from a pocket formed by complementary recesses of first and second mold halves, the first cutting arrangement being a first one of a pinch bar arrangement and a blade arrangement, wherein the pocket extends over the first and second mold halves; and
removably fastening a second one of the pinch bar arrangement and the blade arrangement onto the mold in the pocket formed by the complementary recesses.

13. The method of claim 12, wherein the removably fastening comprises fastening a blade and a bed blade onto the mold in the pocket formed by the complementary recesses, the blade and the bed blade forming complementary cutting pieces.

14. The method of claim 12, wherein the removably fastening comprises using at least one of a screw, a pin and a friction-fit surface.

15. The method of claim 12, further comprising removably fastening the first one of the pinch bar arrangement and the blade arrangement in the pocket before the removing of the first cutting arrangement, wherein the removing of the first cutting arrangement comprises unfastening the first one of the pinch bar arrangement and the blade arrangement from the pocket.

16. The method of claim 12, wherein the removably fastening comprises fitting the blade arrangement substantially within the pocket.

17. The method of claim 12, wherein a width of the pinch bar arrangement is substantially the same as a width of the blade arrangement.

18. A method comprising:
placing a material between first and second mold halves, the first and second mold halves having complementary recesses that form a pocket extending over the first and second mold halves when the mold is closed, wherein a blade comprising a blade edge fits within the pocket and is removably fastened onto the first mold half in the pocket formed by the complementary recesses; and
cutting the material placed between the first and second mold halves with the blade.

19. The method of claim 18, further comprising removably fastening a bed blade onto the second mold half in the pocket formed by the complementary recesses, wherein the blade and the bed blade form complementary cutting pieces.

20. The method of claim 18, further comprising removably fastening the blade onto the first mold half by at least one of a screw, a pin and a friction-fit surface.

21. The method of claim 18, wherein the cutting comprises closing the mold formed of the first and second mold halves.

22. The method of claim 18, wherein the material is a parison.
